(19) United States
(12) Patent Application Publication
(10) Pub. No.: US 2009/0166171 A1
(43) Pub. Date: Jul. 2, 2009

(54) Trifunctional membrane tube arrays

(75) Inventors: Kevin W. Smith, Houston, TX (US); Robert L. Sloan, Katy, TX (US); Patrick F. Hobbs, Houston, TX (US); Harry D. Smith, JR., Montgomery, TX (US)

Correspondence Address: William L. Krayer, 1711 Helen Drive, Pittsburgh, PA, 15216, US

(73) Assignee: Total Separation Solutions LLC

(21) Appl. No.: 12/006,362

(22) Filed: Jan. 2, 2008

(51) Int. Cl. B01D 3/10

(52) U.S. Cl. 203/12; 202/176

(57) ABSTRACT

Membrane tubes or similar membrane devices are arrayed in layers so that liquid placed on their outer surfaces may be evaporated and also drain onto lower membrane devices. The entire array is subjected to moving air to enhance evaporation. The membrane devices function as filters while permeating water from industrial fluids while also providing evaporative surfaces to reduce the volume of used aqueous industrial fluids. The retentate surfaces of the membrane devices may also be on the interiors of the devices, and the permeate contacted with flowing air to evaporate the permeate. Unevaporated permeate is collected in either configuration for use as clean water, and concentrated fluid may be more easily handled, disposed or, and/or its components recycled. A cavitation device may be used to heat the aqueous industrial fluid to enhance permeation and evaporation rates with minimal scaling.

### TECHNICAL FIELD

Permeation devices such as membrane tubes are arranged in arrays simultaneously to filter, serve as evaporation surfaces, and separate by permeation or pervaporation. An industrial fluid, such as a well fluid may be heated prior to introduction to the array, to assist in the evaporation step; heating may be accomplished in a scale-inhibited manner in a cavitation device. The membrane devices are arranged so that unevaporated liquid may fall by gravity from the surfaces of higher membrane devices to lower membrane devices also to enhance evaporation.

### BACKGROUND OF THE INVENTION

In oil and other hydrocarbon production, drilling, completion and workover fluids are typically circulated down the string of tubes and upwards around the outside of the tubes, contacting the formation exposed by the wellbore from which the hydrocarbons are to be produced. In the case of a completion, drilling, or workover fluids, an original clear brine is typically prescribed to have a density which is a function of the formation pressure. Oil well fluids may include calcium, zinc, ammonium and/or cesium as cations, and chloride, formate and particularly bromide as anions from any source. Typical sources include cesium chloride or formate, calcium chloride, sodium chloride, sodium bromide, calcium bromide, zinc chloride, zinc bromide, ammonium chloride, and mixtures thereof as well as their cation and anion forming moieties from other sources. The salts and other additives in the completion, drilling, or workover fluid may be diluted by the formation water or other connate fluids, as a result of contact with the formation. Brines can also become diluted deliberately by the well operator, who may add water to replace fluid lost into the formation, or to reduce the density following a decision that it is too high. Oilfield fluids commonly include as ingredients not only various salts but also polymers, corrosion inhibitors, densifying agents such as barium compounds, biocides, solids such as mud additives, and other compounds. Used fluids also include solids such as drill cuttings and particles from the formation. Whether or not they are diluted, the oil field operator is ultimately faced with the problem of disposal or reuse of the fluids or at least some of their components. Frequently, finding a permissible site for disposal of such solutions and slurries is difficult and very expensive Disposal is also difficult for other common oil well fluids such as water/oil (or oil/water) emulsions of widely varying composition, including muds. If the excess water in dilute fluids is not eliminated or recovered for various purposes, the volume of fluid at the wellsite continues to increase. The cost of trucking to an approved disposal or processing site can be prohibitive in many instances, and accordingly a significant reduction in the volume of such materials is needed in the art. All such fluids originating in the hydrocarbon production industry—the oil and gas fields—may be referred to herein collectively as “oil well fluids or oilfield fluids.”

Each site presents its own problems, but generally the prospect of hauling large quantities of such materials to distant approved disposal sites is not attractive, nor is it inexpensive to do so. Where the brines include significant amounts of dense salts such as calcium and zinc bromide, the transport problem is not only one of quantity, but also of significant weight. Whether the problem appears offshore, or in a remote production area, or in an area having significant human population, it is a difficult one to resolve with positive or minimal environmental consequences.

Other aqueous industrial fluids present similar problems. Wherever large industrial filters are used, the filtration process may benefit from a reduction in the volume of fluid. That is, volume reduction may be beneficial to many other industrial fluids, in addition to used oilfield fluids, simply by reducing the throughput of one or more filters. The pulp and paper industry, the kaolin clay industry, various ore processing practices, and many types of food waste processes come to mind as potential beneficiaries of a system for reducing the sheer volume of fluid handled.

The invention is useful for all such fluids, including oil well fluids, which may be collectively referred to herein as “industrial fluids.” They will all include at least some water which is to be removed.

There is a general need for an efficient and inexpensive way to reduce the sheer volume of used aqueous industrial fluids. There is a need for an efficient and inexpensive way to reduce the amount of used oilfield drilling, workover, and completion fluids for disposal.

### SUMMARY OF THE INVENTION

We have invented a method and apparatus for reducing the quantity of aqueous industrial fluids, including used oilfield fluids, at a given site.

Our invention includes evaporation, the separation by membrane of clean or substantially pure water, and the filtration and concentration of used fluid. The clean water and concentrated fluid can be, in some instances, at least partly reused. The evaporation, permeation, and filtration procedures are combined in a unique way to assure only the most minimal corrosion and scale formation, if any. It will be seen below that the evaporation and water removal aspects of the invention benefit from heating of the aqueous fluid. The heat may come with the fluid—that is, it may be a characteristic of a process fluid which needs to be treated—or the heat may be added in our process. As will be seen below, we may heat the fluid by a cavitation device. Various arrangements of membrane devices are used.

Where the fluid requires heating, we may use any convenient method to heat the fluid, but we find that a technique we call “cavitation” is very useful in an oilfield production site, and for other industrial fluids, presenting little risk of scale formation.

A paradigm of a cavitation path is a path including cavities capable of alternately creating and imploding low-pressure vacuities in the fluid.

Shear stress devices include, broadly, dynamometers (some of which have come to acquire that name in spite of the fact they may not measure anything) and water brakes. Water brakes and other types of absorbing dynamometers convert the energy of a rotor on a turning shaft into thermal energy due to the turbulence and/or shear stress generated in the fluid in which it is immersed. Electric heating devices of various known kinds can be used to elevate the temperature of the fluid, as can various heat exchangers acting to transfer waste heat from Diesel engines, compressors and the like which may be present at the site, microwave heaters, and any other conventional heaters, although we prefer to use cavitation techniques because of their low risk of scale formation.

The design of most cavitation devices is such that at least some turbulence, friction and shearing is effected apart from any cavitation phenomena. While cavitation is to be avoided in many devices such as conventional pumps, a cavitation device may be designed deliberately to generate heat, and such a device can be quite effective in our invention.

Definition: We use the term “cavitation device,” to mean and include any device which will impart thermal energy to flowing liquid by causing bubbles or pockets of partial vacuum to form within the liquid it processes, the bubbles or pockets of partial vacuum being quickly imploded and filled by the flowing liquid. The bubbles or pockets of partial vacuum have also been described as areas within the liquid which have reached the vapor pressure of the liquid. The turbulence and/or impact, which may be called a shock wave, caused by the implosion imparts thermal energy to the liquid, which, in the case of water, may readily reach boiling temperatures. The bubbles or pockets of partial vacuum are typically created in a cavitation device by flowing the liquid through narrow passages which present side depressions, cavities, pockets, apertures, or dead-end holes to the flowing liquid; hence the term “cavitation effect” is frequently applied, and devices known as “cavitation pumps” or “cavitation regenerators” are included in our definition. Steam or vapor generated in the cavitation device can be separated from the remaining, now concentrated, water and/or other liquid which frequently will include significant quantities of solids small enough to pass through the reactor. The term “cavitation device” includes all the devices described in U.S. Pat. Nos. 5,385,298, 5,957,122 6,627,784 and 5,188,090, all of which are hereby expressly incorporated herein in their entireties. The term “cavitation device” also includes any of the devices described by Sajewski in U.S. Pat. Nos. 5,183,513, 5,184,576, and 5,239,948, Wyszomirski in U.S. Pat. No. 3,198,191, Selivanov in U.S. Pat. No. 6,016,798, Thoma in U.S. Pat. Nos. 7,089,886, 6,976,486, 6,959,669, 6,910,448, and 6,823,820, Crosta et al in U.S. Pat. No. 6,595,759, Giebeler et al in U.S. Pat. Nos. 5,931,153 and 6,164,274, Huffman in U.S. Pat. No. 5,419,306, Archibald et al in U.S. Pat. No. 6,596,178 and other similar devices which employ a shearing effect between two close surfaces, at least one of which is moving, such as a rotor, and/or at least one of which has cavities of various designs in its surface as explained above.

For evaporation, we may use a cooling tower type of construction in which the evaporation surfaces comprise membranes capable of filtering and through which water may permeate; we may utilize a vacuum or other applied pressure difference to assist the permeation or pervaporation. Any membrane known to be useful in vacuum distillation may be used. Any membrane may be used which is known for its ability to pass water, or water vapor while excluding liquid water, desirably from a relatively hot aqueous liquid on one side to a relatively cool condensate surface on the other. Both organic and inorganic membranes are available in commerce. For example, porous ceramic membranes having a mean pore diameter down to 1 nanometer are used for water treatment applications.

Both hydrophilic and hydrophobic polymeric pervaporation membranes are available also. Frequently the membrane comprises several plies; some membranes are designed to swell and others to resist swelling. Some are laid down on the insides of porous tube supports, including spiral wound and glass fiber reinforced synthetics, while others are deposited on the exteriors of porous support tubes or as flat sheets on nonwoven supports. Inorganic membranes may include a significant Zeolite component. Many polymeric and inorganic membranes, together with their supports, are built to withstand temperatures of up to 250°. Some specialty membranes are designed to resist low pH's and others are useful for fluids containing alcohols or other specific types of chemicals. Depending on the type of industrial fluid to be reduced in volume, we may use membranes designed for microfiltration, ultrafiltration, nanofiltration, or reverse osmosis. Thus our definition of the term “membrane” as used herein includes all of the variations just mentioned (such as the “other media” and “similar materials,” whether ceramic, organic, including polymeric, metallic, sintered, or any other material mentioned herein); and capable of separation of at least one component (whether dissolved or not) of the fluid in the range down to one nanometer or even less, regardless of thickness. The membrane may be considered porous or nonporous. The separation effect may be considered vapor permeation, pervaporation, liquid permeation, ultrafiltration, reverse osmosis, or any other phenomenon or mechanism so long as water and/or water vapor is passed through the membrane and at least one component of the fluid is retained.

Generally, hydrophobic membranes are preferred where it is desired to permit only water vapor, and not water droplets, to pass. If water droplets pass through the membrane, they may carry dissolved salts with them, which is counterproductive for the purpose of obtaining fresh water. However, we do not intend to disclaim the use of hydrophilic membranes, particularly as their properties may be improved in the future to adequately reject dissolved salts. Moreover, in the processing of some types of aqueous fluids it may not be undesirable to pass one or more types of salts through the membrane along with liquid water. Both types of membranes are well known in the art of desalination, medical applications, and for other purposes. Any membranes which will perform as described herein are contemplated in our invention. It should be remembered that our primary objective is to reduce the volume of the industrial fluid, not necessarily to make a pure water, although there are many circumstances in which substantially pure water would be economically advantageous and will be obtained because of the properties of the membrane.

As will be seen below, the membrane is built into what we call a “membrane device,” two variations of which are illustrated in FIGS. 2a and 2b. The fluid and the membrane are subjected to “permeation conditions,” which we define as the conditions under which at least some permeation will take place through the membrane; this will generally mean that a pressure difference, usually together with a temperature difference, is imposed across the membrane sufficient to effect at least some permeation of steam, vapor, or water, which may or may not contain some dissolved salts. The pressure difference may be imposed either by a positive pressure on the retentate side or a negative pressure on the permeate side, or both. In addition to pressure difference, permeation conditions may vary somewhat with the type of membrane, and its specifications, the composition of the fluid, the flow rate of the fluid, and whether the membrane surface is partially fouled by components of the fluid. “Permeation” as used herein means primarily permeation by water, and “water-permeable” includes the ability to permeate water vapor as well as liquid water. “Permeation conditions” as used herein thus means conditions under which either water or water vapor will be passed through the membrane, and this includes an effective pressure difference across the membrane, which may arise from any combination of pressures above, below, or equal to atmospheric.

Our invention includes the optional distinct step, where a heater is used to heat the fluid, of filtering the fluid before it enters the heater, or after it is heated and before it is applied to the membrane devices for permeation, evaporation, or pervaporation. Because the cavitation device is able to handle large proportions of solids in the fluid it heats, our invention enables the postponement of filtration until after the fluid is reduced in water content by passing through the cavitation device to heat it and facilitate removal of vapor; filters and the filtration process can therefore be engineered to handle smaller volumes of liquid with higher concentrations of solids obtained at various stages of the process.

### BRIEF DESCRIPTION OF THE DRAWINGS

FIG. 1 is an outline/conceptual drawing of our invention using dead-end membrane devices simultaneously for evaporation, for filtering, and as a fresh water generator through permeation. A vacuum is applied to the interiors of the membrane devices.

FIG. 2a illustrates a vacuum-assisted “dead end” tubular membrane device used in our invention for filtration, evaporation, and permeation. FIG. 2b shows in detail a vacuum-assisted membrane device in substantially planar form.

In FIG. 3, the membrane device configuration of FIG. 1 is modified in four independently optional ways. This Figure shows a heater for the incoming industrial fluid, vacuum-assisted dead-end permeable membrane tubes in the collector pool, recycling of the concentrated fluid from the pool, and the injection of hot gas to the membrane tree structure.

FIG. 4 illustrates a cavitation device useful as a fluid heater (cavitation device) in our invention where heating is needed.

FIG. 5a shows, conceptually, a variation of our fluid reduction structure in which the hot incoming fluid is introduced to the interiors of the cross-flow membrane devices in series. In FIG. 5b, fluid is also introduced to the interiors of the membrane devices, which are dead end devices.

### DETAILED DESCRIPTION OF THE INVENTION

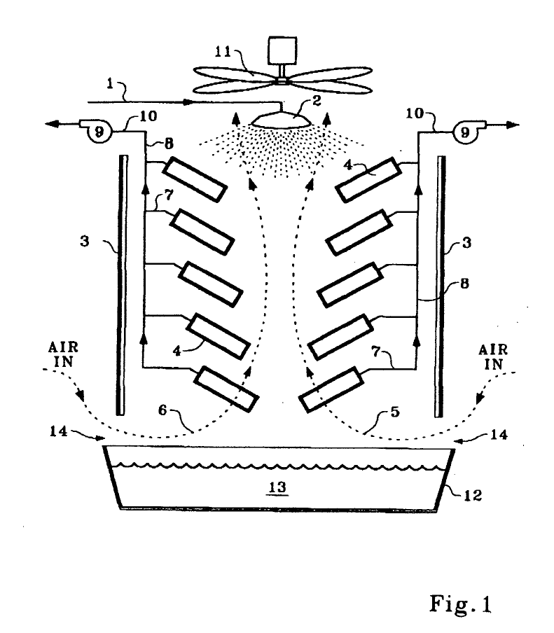

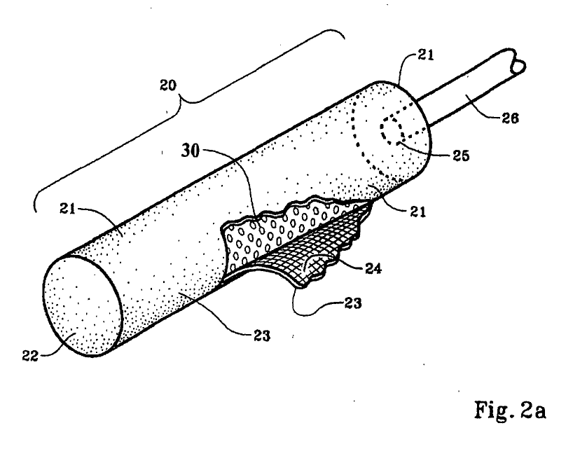

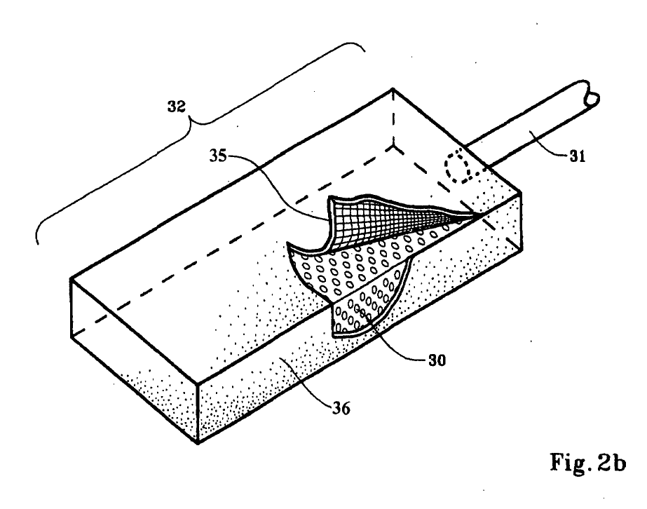

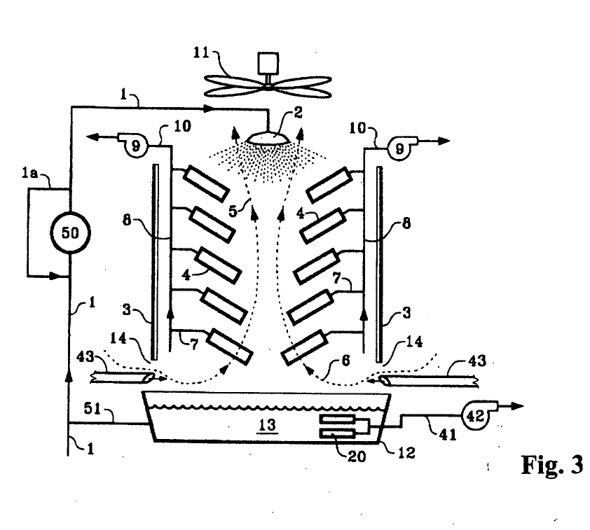

Referring now to FIG. 1, a used industrial fluid, desirably warm, hot or heated, passes through line 1 with the possible aid of a pump not shown and possibly having passed through an optional filter not shown. It is distributed through a spray device such as nozzle 2 near the top of shroud 3. Within shroud 3 are a plurality of water-permeable membrane devices 4, each having a membrane on its exterior surface, or a portion of its exterior surface, as will be detailed in FIGS. 2a and 2b. The exterior surfaces of the membranes in this configuration may be called retentate surfaces, illustrated in FIGS. 2a and 2b. The membrane is held in a housing defining an interior space or chamber under the permeate side of the membrane, as will be seen in more detail in FIGS. 2a and 2b. Spray from nozzle 2 falls mostly on uppermost membrane devices 4, which in this embodiment are inclined somewhat to encourage the sprayed fluid to drain from them to additional membrane devices 4 below. The interior spaces of membrane devices 4 are connected to vacuum lines 7 which in turn connect to manifold 8. A pump 9 draws a vacuum or negative pressure on manifold 8 through line 10. The vacuum or negative pressure thus imposed is exerted on the interiors of membrane devices 4, establishing a pressure difference across the membranes and assisting in the permeation of water or vapor through the water-permeable membranes on membrane devices 4. Because the vacuum causes an increased flow of water through the membranes, draining of the fluid by gravity from the retentate surface is somewhat retarded, and the residence time of the fluid on the membrane surface is higher than it would be otherwise. A suction fan 11 is positioned above the spray, to generate an air flow past and in contact with the membranes, further retarding the downward flow of liquid on the membrane devices 4, and encouraging evaporation of water from the membrane surfaces. Opening 14 below shroud 3 assures a plentiful flow of relatively dry air from below the membrane devices 4 to fan 11, as indicated by dotted lines 5 and 6. Any solids contained in the fluid are rejected by the retentate surfaces of the membrane (FIGS. 2a and 2b) and will fall along with the unevaporated and unpermeated fluid, which is cooled by the loss of the heat of evaporation to the vapors released into the atmosphere. The solids will settle on the bottom of collector 12, which may be shaped to facilitate their removal. Fluid not evaporated or permeated falls to pool 13 in collector 12 below shroud 3. The fluid in pool 13 is thus both concentrated and cooled. Because of evaporation from, and permeation through, the membrane, the volume of pool 13 is considerably less than the fluid introduced through line 1, and, being concentrated, lends itself to various methods of recovering components from it for reuse.

The illustration of FIG. 1 is simplified and conceptual—in particular, there will desirably be a much larger number of membrane devices 4. Membrane devices 4 are arrayed in three dimensions and may be in more or fewer levels than the four depicted in FIG. 1. They should be arranged so the unevaporated fluid on the upper membrane devices will tend to fall on lower membrane devices rather than directly to pool 13, in order to maintain more exposure to the membrane surfaces. While it is desirable for the membrane devices to converge slightly downwardly toward the center of shroud 3 as shown, so that the unpermeated and unevaporated fluid will tend to flow toward the center of the array, this is not essential. The layers of membrane devices may diverge or fan out instead, or be set in any other convenient pattern, but it is also desirable that the entire spray from nozzle 2 should be placed on the upper levels of membrane devices 4 and that the lower levels of membrane devices 4 be deployed to receive as much of the drainage as possible from the upper levels. Desirably, the spray will initially contact the uppermost or second level of membrane devices 4. The incoming or dirty fluid thus sprayed will therefore be simultaneously (a) filtered by the membrane devices, (b) evaporated by the air moving upwards, and (c) reduced in volume by the vacuum drawing clean water and/or water vapor permeate through the membranes on the membrane devices. The remaining dirty fluid falls into pool 13.

The purity, cleanliness, and/or freedom from salts of the permeate will depend to at least some extent on the particular type of membrane used, but the permeate will desirably be substantially clean water which may be used for any of the many purposes for clean water.

It should be understood that shroud 3 may be cylindrical, rectangular, or any other convenient shape, and need not surround the structure entirely; there may be openings in it. Shroud 3 may be constructed in parabolic form or otherwise to induce a natural draft to supplement or replace the fan 11.

FIG. 2a illustrates a tubular membrane device of a type which is useful in our invention as the membrane device 4 in FIG. 1. The generally tubular water-permeable membrane device 20 has an outer surface 21 of a hydrophobic, hydrophilic, or other membrane and may be closed off at the end by a water-impermeable closure 22. The membrane has a retentate surface 23 (the exterior of the device 20) and a permeate side 24, and, if not self-supporting, including a porous support 30, seen in the broken-away portion of the illustration. The porous support 30 may also provide secondary filtration if desired. The end opposite closure 22 has an opening 25 to which a tube 26 is attached for imposing a vacuum or negative pressure on the hollow interior of the device 20 in order to assist with the permeation process. Tube 26 may act as or be connected to the vacuum line 7 in FIG. 1 for connection to a manifold such a manifold 8 in FIG. 1 and further to a source of negative pressure such as vacuum pump 9 to induce permeation through the membrane and to remove permeate from the interior of the device. Tubular membrane devices 20, having exterior membranes, may serve as membrane devices 4 in FIG. 1.

The membrane devices 4 of FIG. 1 may be any device having a membrane as defined above on at least a portion of the outside surface and an enclosed void below the membrane—that is, within the interior of the device. Support for the membrane may be a rigid or semi-rigid porous plastic such as a polyester or other known material, ceramic, permeable metal or the like. We also may use porous tubes or other devices so long as they are capable of passing clear permeate, preferably permeate free of dissolved salts in some applications. The membrane devices may be tubular (with a dead end), or rectangular, or any other shape.

FIG. 2b illustrates another construction, membrane device 32, which may be used as the membrane devices 4 of FIG. 1. Membrane 35 substantially covers the surface area which will be deployed to receive spray from nozzle 2. The membrane is desirably hydrophobic, although the use of other membranes also designed to permit the permeation of water and/or water vapor and virtually nothing else is also possible, and in that sense may be called permselective. Any other membrane as defined above may be used. Membrane 35 is mounted on housing 36, defining an interior space, which is closed off except for a connection to tube 31. Tube 31 will be connected to a source of vacuum or negative pressure such as line 10 in FIG. 1 to assist in the permeation of water through the membrane 35. Membrane 35 has a retentate surface to be exposed to the industrial fluid and a permeate surface on its underside, as is known in the art. Membrane 35 may cover only a portion of the surface of membrane device 32.

Membrane devices 32 and 20 are examples of such membrane devices 4 which are useful in our invention, particularly the configuration of FIG. 1, and we do not intend to be limited to their particular construction. The membrane devices need not be either generally tubular nor generally oblong. The membrane devices need only be capable of presenting significant surface area to the falling spray, include a membrane capable of passing water while rejecting or retaining small solids, and include an interior enclosure to which the permeate side of the membrane is exposed, so water and/or water vapor can be encouraged to permeate through it and be readily collected. The planar membrane devices of FIG. 2b will desirably be inclined as in FIG. 1, but because of the cylindrical shape of the tubular devices of FIG. 2a, it is not essential to place them at an angle to assure drainage onto the next lower flight of membrane devices. A falling film will form on the devices of either shape, and it should be remembered that a spray is not essential to form a falling film—we intend to include within our invention any method or device for forming a falling film on the membrane devices, or otherwise placing the industrial fluid on them. Fluid on the membrane devices 4 will also be in the form of droplets either directly from the spray or falling from other membrane devices above. When a vacuum is drawn on the interiors of the membrane devices, some air may be drawn through the membrane as well as water; in addition, air is likely to be present in the interior space of the device when it is first installed. If air from any source becomes mixed with the fresh water drawn through the membrane, it need not disturb the operation of the vacuum pump and in any event the air and water can be separated by any convenient means. Passage of air into the membrane devices may be reduced by avoiding constructions having membranes on the undersides of the membrane devices.

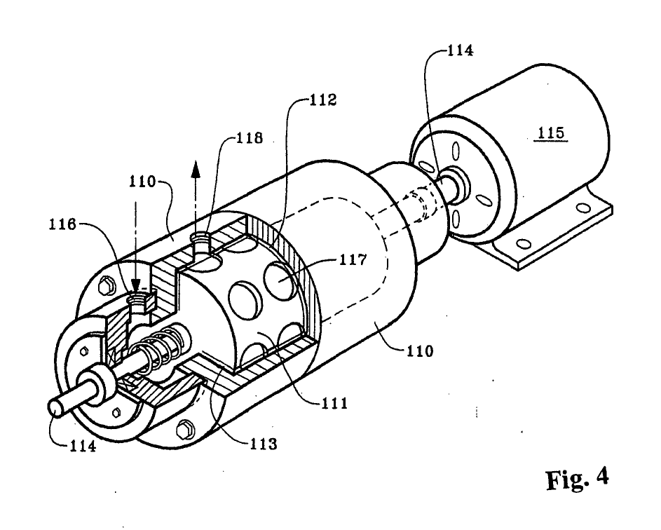

In FIG. 3, the system of FIG. 1 is shown with four optional modifications which may be used independently. First, it will be seen that a heater 50 is shown in incoming line 1. As indicated above, it is contemplated that our invention is useful for industrial fluids which are already heated in the industrial process from which they emanate. Where they are not, a heater may be used. The heater 50 can be any heater capable of heating the incoming fluid in line 1. For example, the heater may be a gas-fired heater, an electric heater, or one of the cavitation devices described above and particularly in FIG. 4. Or, it could be a waste heat exchanger—for example one designed to utilize the waste heat from a Diesel engine exhaust. Heating may be accomplished by more than one device—that is, more than one heater, heat exchanger, or combination of them. The heater will enhance the evaporation of industrial fluid placed on membrane devices 4 and also enhance the permeation conditions for the membranes in them.

The second difference from FIG. 1 is that dead end tubular membrane devices 20 (see FIG. 2a) are immersed in the pool 13. Being immersed, they will not encourage evaporation from their exterior surfaces like the membrane devices 4 of FIG. 1, but they will filter, and the vacuum drawn through line 41 by pump 42 will enhance the rate of permeation and/or pervaporation through the membranes. Because liquid and/or vaporous water is drawn into the membrane devices 20, the fluid in pool 13 is further concentrated, and additional fresh water is made and evacuated for collection from line 41. The type of membrane, the temperature of the aqueous fluid in pool 13, and the pressure difference across the membrane are variables of the permeation conditions that determine the quality and quantity of permeate recovered by this technique. Higher temperatures generally mean more efficient performance. It should be noted that if the fluid in pool 13 is further concentrated by removal of permeate through permeation devices 20 or otherwise, or even if not, as in FIG. 1, the concentrate in pool 13 can serve as a source of components for recycled or new makeup of the treated industrial fluid. In some cases, the industrial fluid may simply have become too dilute for effective use, and our invention may in that case enable immediate recycling to a well (or an intermediate holding tank) from pool 13.

The third independent difference from FIG. 1 is that a recycle line 51 has been installed to further concentrate the fluid in pool 13 by recycling it to line 1. In most cases, this will be done where the fluid is to be heated in a heater such as heater 50, and therefore will recycle to a point upstream of heater 50 as shown, but, particularly if the incoming fluid is already quite hot from the industrial process from which it emanates, the recycle line 51 can simply be joined to line 1 so the recycle fluid can mix with the incoming fluid, without a need for additional heat input. Depending on total permeation rates, evaporation rates, flow rates, pressure differences, and other variables, it may be desirable to recycle as much as five or six times the volume of incoming new industrial fluid. We may use recycle fluid at a flow rate from pool 13 in a ratio to new fluid of from 1:20 to 20:1; desirably the ratio may be from about 1:1 to about 10:1. The rate of evaporation can be enhanced, and the ratio reduced, by heating the incoming air, an example of which is discussed below.

Recycling may also be optionally practiced in a simple loop around heater or cavitation device 50, as illustrated by line 1a, to increase the temperature of the fluid in line 1. Again, the ratio of recycled fluid may vary considerably; for example also from 1:20 to 20:1.

The fourth independent modification of FIG. 1 shown in FIG. 4 is that the air entering below shroud 3 is first heated in a heat exchanger. As an example of this, a Diesel engine exhaust pipe 43 is shown. The exhaust gas itself may be aimed directly into the opening 14 between shroud 3 and collector 12, or the air drawn by fan 11 may simply pass by the exhaust pipe 43, or an extension of it, to pick up heat by conduction and convection before entering the space defined by shroud 3, as indicated by dotted lines 5 and 6. The Diesel engine is not shown, as it may be present for any purpose, such as operating a pump or a compressor. As with the source of heat utilized in the first mentioned difference above, any other source of heat on site may be used to heat the air entering the space defined by shroud 3.

FIG. 4, illustrating an example of a cavitation device, is taken from FIG. 1 of Griggs U.S. Pat. No. 5,188,090, which is incorporated herein by reference in its entirety as indicated above. As explained in the U.S. Pat. No. 5,188,090 and elsewhere in the above referenced cavitation device patents, liquid is heated in the device without the use of a heat transfer surface, thus avoiding the usual scaling problems common to boilers and distillation apparatus. When used as the heater 50 in FIG. 3, the cavitation device will drastically alleviate the scaling problem common in many evaporation systems.

A housing 110 in FIG. 4 encloses cylindrical rotor 111 leaving only a small clearance 112 around its curved surface and clearance 113 at the ends. The rotor 111 is mounted on a shaft 114 turned by motor 115, which may be replaced by a Diesel engine or other rotation source. Cavities 117 are drilled or otherwise cut into the surface of rotor 111. As explained in the Griggs patents, other irregularities, such as shallow lips around the cavities 117, may be placed on the surface of the rotor 111. Some of the cavities 117 may be drilled at an angle other than perpendicular to the surface of rotor 111—for example, at a 15 degree angle. Liquid—in the case of the present invention, an aqueous industrial fluid—is introduced through port 116 under pressure and enters clearances 113 and 112. As the fluid passes from port 116 to clearance 113 to clearance 112 and out exit 118, areas of vacuum are generated within the cavities and heat is generated within the liquid from its own turbulence, expansion and compression (shock waves). As explained at column 2 lines 61 et seq in the U.S. Pat. No. 5,188,090, “(T)he depth, diameter and orientation of (the cavities) may be adjusted in dimension to optimize efficiency and effectiveness of (the cavitation device) for heating various fluids, and to optimize operation, efficiency, and effectiveness . . . with respect to particular fluid temperatures, pressures and flow rates, as they relate to rotational speed of (the rotor 111).” Smaller or larger clearances may be provided. Also the interior surface of the housing 110 may be smooth with no irregularities or may be serrated, feature holes or bores or other irregularities as desired to increase efficiency and effectiveness for particular fluids, flow rates and rotational speeds of the rotor 111. Rotational velocity may be on the order of 5000 rpm. The diameter and location of the entrance port 116 and/or of the exhaust ports 118 may be varied also depending on the fluid treated. The machine is very versatile in that considerable variation in pressures and temperatures may be used. Pressure at entrance port 116 may be 75 psi, for example, and the temperature at exit port 118 may be 300° F.

Operation of the cavitation device is as follows. A shearing stress is created in the fluid as it passes into the narrow clearance 112 between the rotor 111 and the housing 110. This shearing stress (shear thinning) causes an increase in temperature and/or a reduction in viscosity. The fluid quickly encounters the cavities 117 in the rotor 111, and tends to fill the cavities, but the centrifugal force of the rotation tends to throw the liquid back out of the cavity, which creates a vacuum. The vacuum in the cavities 117 draws liquid back into them, and accordingly “shock waves” are formed as the cavities are constantly filled, emptied and filled again. Small bubbles, some of them microscopic, are formed and imploded. All of this stress on the liquid generates heat which increases the temperature of the liquid dramatically, enhancing the efficiency of the membrane devices when the heated fluid contacts them. The design of the cavitation device ensures that, since the bubble collapse and much of the other stress takes place in the cavities, little or no erosion of the working surfaces of the rotor 111 takes place. Any solids present in the solution, having dimensions small enough to pass through the clearances 112 and 113 may pass through the cavitation device unchanged except in concentration where water is removed.

Temperatures within the cavitation device—of the rotor 111, the housing 110, and the fluid within the clearance spaces 112 between the rotor and the housing—remain substantially constant after the process is begun and while the feed rate and other variables are maintained at the desired values. There is no outside heat source; it is the mechanical energy of the spinning rotor—to some extent friction, as well as the above described turbulence, shear, and cavitation effects—that is converted to heat taken up by the solution and soon removed along with the solution when it is passes through exit 118. The rotor and housing 110, particularly in its interior, indeed tend to be lower in temperature than the liquid in clearances 112 and 113. There is little danger of scale formation even with high concentrations of heavy brine components in the solution being processed.

Any solids present in the solution, having dimensions small enough to pass through the clearances 112 and 113 may pass through the cavitation device unchanged. This may be taken into account when using the reconstituted solution in for oil well purposes.

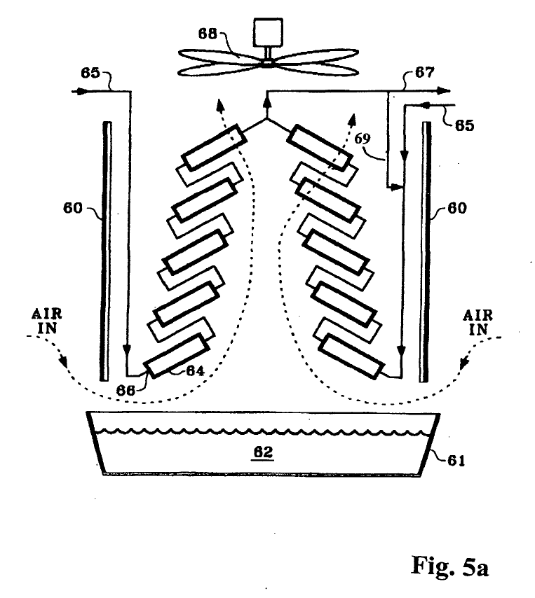

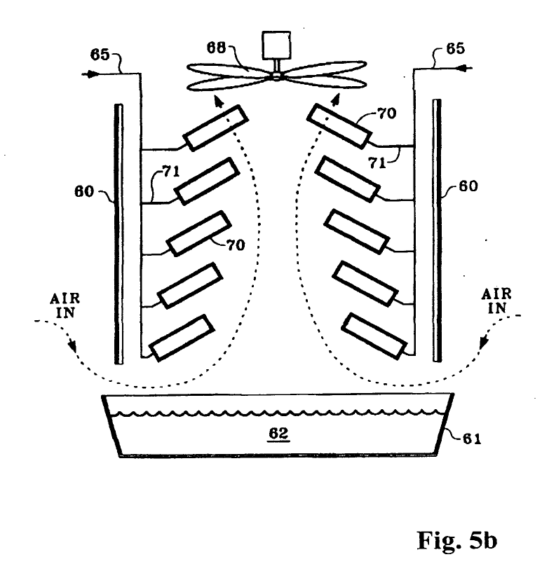

Unlike the processes of FIGS. 1 and 3, FIGS. 5a and 5b show water volume reduction accomplished by contacting the raw fluid with a membrane device having its membrane placed on the internal surface of a tube or other enclosure; permeate passing through the membrane and arriving on the external surface is then exposed to flowing air to evaporate it. In FIG. 5a, the membrane devices are deployed in a cascaded cross-flow series and in FIG. 5b they are also cascaded but “dead end,” with fluid fed into each from line 65. Because it is the permeate that is evaporated on the outside of the membrane device in FIGS. 5a and 5b, there is no spray as in FIG. 1. Referring now to FIG. 5a, shroud 60 substantially surrounds a space above collector 61, which contains pool 62, similar to the shroud 3, collector 12 and pool 13 of FIG. 1. Membrane devices 64 are arrayed in slightly diverging layers from top to bottom. They are similar to those of FIG. 2a but have a tube 26 at each end so that fluid may pass through them. The fluid to be reduced in volume is heated, desirably by cavitation, for example by the cavitation device of FIG. 4, for introduction through line or lines 65, and first enters the membrane devices on the lower level, at connections 66. Line 65 may include a filter not shown. Membrane devices 64 have a membrane deposited on their internal surfaces rather than on the outside as illustrated in FIGS. 2a and 2b. Connections 66 may be made separately from line 65 or through an intermediate manifold or header not shown, which may encircle the lower layer or level of membrane devices 64. It should be understood that the number of membrane devices 64 in the several layers of membrane devices will be determined roughly by the expected permeation rate, which will in turn depend on the composition of the fluid, the permeation specifications of the membrane devices, and the proposed flow rate and pressure through the membrane devices. The lowest level may, for example, contain forty-eight (48) membrane devices, the next higher lever thirty-two (32), the third level from the bottom twenty (20), and the uppermost level may contain fourteen (14) membrane devices. As may be seen from FIG. 5a, in the cross-flow mode, fluid passing through the membrane devices 64 on the lowest level is sent to the next level in a cascade or series configuration, then on to the next higher level, and finally to the top level. Fluid thus passes through a plurality of membrane devices 64 in series, diminishing in volume somewhat with each pass.

If one-half the fluid volume is permeated at each level (whatever the number of membrane devices), the concentrate passed into concentrate line 67 would be only one-sixteenth of the original volume. The permeation or other transport rate of vapor or liquid through the membrane devices will not normally be so great, however; in addition, the increasing concentration of solids in the retentate must be reckoned with. Nevertheless, a recycle line 69 is shown for recycling a portion of the concentrated fluid from line 67 to line 65 and again through membrane devices 64. Recycling may be practiced for the entire tree of membrane devices, or for some of them, such as a flight, level, or series served by a manifold, or for a single membrane device. Volume or flow ratios for recycle may vary considerably—for example, as much as 99% of the fluid exiting from a single membrane device may be recycled from its exit to its own entrance, regardless of the amount of fluid permeated through the membrane. The remainder may be passed to the next membrane device. Such recycling may be used in any of the cross flow configurations contemplated herein—that is, where the industrial fluid to be treated is passed through the interior space of a tube or other membrane device under pressure to extract a permeate. Recycling may alternatively send fluid back more than one membrane device.

In FIG. 5a, permeate passing through the membrane is immediately subjected to the evaporating action of air drawn upwards within the shroud 60 by fan 68. In the configurations of FIGS. 5a and 5b, the air flow caused by suction fan 68 is intended to encourage evaporation of permeate or to remove water of either a vapor or liquid phase emerging from the membrane devices 64. Liquid which falls to pool 62 in collector 61 is generally clean fluid, as opposed to the concentrate collected by pool 3 in FIG. 1. Concentrate in line 67 of FIG. 5a may be transported for disposal or other use, such as the extraction of valuable components or the reuse of the entire fluid, far less expensively than the large original volume.

Incoming fluid in line 65 is heated, preferably by a cavitation device or other heater not shown, as pervaporation and other transport through the membranes is known to be enhanced at higher temperatures, and evaporation or permeate from the external surfaces of the membrane devices will also be enhanced if the permeate is warm or hot. It is not important whether the fluid enters the lower end of the membrane devices 64 or the upper end, or whether the sequence is from bottom to top of the tree, or from the top down, or in series on the same level; in either case the fluid is caused to flow while water in it permeates through the membrane on the internal surface of the membrane devices 64 connected in series. The air flowing into shroud 60 and past the membranes may be heated if desired.

In FIG. 5b, shroud 60, collector 61, fan 68, and pool 62 are as in FIG. 5a, but here the “Christmas tree” arrays of membrane devices 70 are not connected in series; rather, they are “dead end” membrane devices. Incoming line 65, again containing fluid heated by a heater not shown, for example a cavitation device such as in FIG. 4, is connected separately to each of the dead end membrane devices 70 through individual lines 71 (which, however, may emanate from one or more intermediate manifolds, not shown, which may encircle the layers of membrane devices). While the lower levels may contain larger numbers of membrane devices as in FIG. 5a, it is not necessary to be aware of a constantly diminishing volume in the membrane devices as in FIG. 5a in order to calculate the number of devices in succeeding levels, since the dead end membrane devices do not pass the concentrated fluid through to the next membrane device. The “Christmas tree” arrangement is useful in this case only as one of many possible configurations of the membrane devices, whose functions are to (a) filter, (b) permeate or pervaporate, and (c) serve as an evaporative surface for the permeate. Here, it will be seen that unevaporated permeate on the upper level will be encouraged to fall on the evaporation surfaces of the next level, and the unevaporated permeate from the second level (as well as any remaining permeate from the uppermost level) may drip onto the third level for further exposure to the sweep air, and so on to the next level.) The membrane devices may be inclined in the direction opposite that shown, i.e. having the fluid entrance on the higher end of each membrane device, in which case the operator may also wish to deploy them more or less as shown in FIG. 1 (an upside down tree). There is no need to have an increasing or decreasing number of membrane devices from top to bottom—any configuration deemed likely to encourage efficient evaporation may be used.

As is known in the art, permeation or pervaporation through a membrane is enhanced by heating, and in this case we find it desirable to heat the fluid sent to the interiors of the membrane devices to a temperature of at least 60° C., but considerably higher temperatures can be used, particularly temperatures near or above 100° C., which will of course considerably improve the rate of evaporation on the exteriors of the membranes. Similar temperature ranges are useful for the membrane devices in series as in FIG. 5a. As the dead end membrane devices of FIG. 5b may tend to become full of solids or otherwise less efficient, they may be discarded and readily replaced with new ones, or simply flushed out and re-installed. As in the process described in FIG. 5a, the inlet air in FIG. 5b may also be heated if desired.

Another phenomenon which may tend to reduce the efficiency of the configurations shown in FIGS. 1, 3, 5a, and 5b is rain or snow where the array of membrane devices has no cover above the shroud and fan. As is known in the cooling tower art, the air draft need not be induced upwardly but can be forced air, and could move substantially horizontally, desirably under a canopy. While we have indicated above that the shroud need not be impervious—it can have “holes” in it—it is also within our invention for the air to be moved horizontally through the membrane device “tree,” either by a forced air fan or a draft drawn through the array. Particularly where a purpose of the membrane device array is to collect a concentrated fluid in collector 12 or 61, precipitation through an open top will tend to defeat that purpose, and accordingly a cover, or overhead shield with appropriate draining, is recommended, and a cross current of air can be used within the membrane device array to much the same effect as the fan 11 or 68 in FIGS. 1, 3, 5a, and 5b. Whether the air is deployed to evaporate permeate or retentate from the membrane surfaces, the quantities of fluid to be evaporated will be similar to those of the upwardly moving air illustrated herein.

The membrane device may be comprised entirely of membrane or may include a support. The reader will recognize that we use and define the term “membrane device” for both cross-flow and dead end devices, and where the flow of permeate may be either into or out of a chamber or other defined space. Our invention utilizes pressure differences across the membranes. Where the fluid to be separated is introduced to the interior of a dead end device, it is introduced under pressure. Permeation conditions and rates are generally enhanced as the pressure is increased. Where the fluid to be separated is introduced to the interior of a cross-flow device such as those connected in series in FIG. 5a, a pressure gradient across the membrane is also desirable, and should be imposed although the fluid will continue to flow through the entire length of the membrane device to its exit. Where permeation is from the external surface to the interior of the membrane device, such as in FIG. 1, or for the membrane devices 20 submerged in pool 13 of FIG. 3, a vacuum is drawn on the device to provide the pressure difference. Any pressure difference will have some effect. The operator should take into account the specifications of the particular membrane devices and the flow rates to be used, among other factors.

It should be understood that all of the variations and configurations discussed above include items not shown, such as valves, pumps, meters, transducers, controllers and other devices necessary to regulate the flows, temperatures, pressures, levels and other variables. Such items will be chosen, programmed and manipulated according to the particular circumstances and desires of the operators.

Our invention therefore comprises an apparatus for reducing the volume of liquid water in an aqueous industrial fluid comprising (a) a cavitation device for heating the aqueous industrial fluid, (b) a shroud, (c) a plurality of membrane devices within the shroud, the membrane devices each including a membrane capable of passing water as liquid or vapor, the membrane having a retentate side and a permeate side, the membrane devices optionally including a porous support for the membrane, (d) means for causing aqueous industrial fluid heated by the cavitation device to contact the retentate side of the membranes under pressure, whereby the aqueous industrial fluid is filtered and water as liquid or vapor may be passed through the membranes to the permeate sides thereof, and (e) means for causing air to flow past the permeate side of at least one of the membranes to facilitate evaporation of permeate therefrom.

Our invention also includes a membrane device tree useful for evaporation of a liquid comprising (a) a plurality of membrane devices deployed in a plurality of levels so that liquid on the highest level may fall onto at least one membrane device on a lower level and (b) a fan for moving air past the membrane devices to enhance evaporation of the liquid, which may be either a permeate or a fluid whose volume is to be reduced.

Our invention also includes apparatus for reducing the volume of liquid water in an aqueous fluid comprising (a) a shroud, (b) at least one water-permeable membrane device within the shroud, the membrane device comprising (i) a water-permeable membrane having an exterior retentate surface and an interior permeate surface, the retentate surface being non-horizontal, and (ii) a permeate enclosure for receiving permeate from the interior permeate surface, (c) means for applying a vacuum to the permeate enclosure for withdrawing permeate through the membrane and from the permeate enclosure, (d) means for applying the aqueous fluid to the retentate side of the at least one water-permeable membrane device, (e) means for causing air to flow in contact with the aqueous fluid on the retentate surface of the membrane and through the open top of the shroud to the atmosphere, and (f) means for collecting aqueous fluid falling by gravity from the exterior retentate surface of the membrane.

Our invention also includes a method of processing an aqueous industrial fluid comprising heating the aqueous industrial fluid, placing the fluid on the retentate surface of a membrane, the membrane having a retentate surface and a permeate surface, causing air to flow past the retentate surface to facilitate evaporation of water from the fluid on the retentate surface, subjecting the permeate surface of the membrane to a vacuum to facilitate the permeation of water through the membrane, and collecting concentrated fluid by allowing it to drain from the retentate surface into a collector from the retentate surface.

In addition, our invention includes a method of reducing the volume of an aqueous industrial fluid having a temperature of at least 60° C. comprising contacting the aqueous industrial fluid under pressure with the retentate sides of the membranes in the interior enclosures of a plurality of membrane devices, the membrane devices comprising membranes having interior retentate surfaces and exterior permeate surfaces, and defining the interior enclosures, thereby filtering the aqueous industrial fluid while also passing water from the aqueous industrial fluid through the membrane devices to the exterior permeate sides of the membranes, contacting the permeate sides of the membranes with flowing air to facilitate evaporation thereof, permitting unevaporated permeate on the permeate side of the membranes to fall by gravity into a permeate collector, and recovering the unevaporated permeate in the collector.

More particularly, our invention includes an array of membrane devices useful for separating phases of an aqueous fluid, the membrane devices being capable of permeating water as liquid or vapor, comprising (a) a plurality of membrane devices, the membrane devices having an exterior and an interior, deployed in a plurality of levels so that aqueous fluid on the exterior of the membrane devices on the highest level may fall by gravity onto the exterior of at least one membrane device on a lower level (b) means for moving air past the exterior of the membrane devices to enhance evaporation of water from the aqueous fluid when it is on the exterior of the membrane devices, and (c) means for moving aqueous fluid into or out of the interior of the membrane devices. In addition, our invention includes a method of processing an aqueous industrial fluid comprising (a) placing the fluid on the retentate surfaces of a plurality of membrane devices, each membrane device having a retentate surface and a permeate surface, (b) causing air to flow past the retentate surface to facilitate evaporation of water from the fluid on the retentate surface, (c) subjecting the permeate surfaces of the membrane devices to a vacuum to assist the permeation of water or water vapor through the membrane device, and (d) collecting concentrated fluid by allowing it to drain from the retentate surface into a fluid collector. Also, our invention includes a method of reducing the volume of an aqueous industrial fluid comprising (a) contacting the aqueous industrial fluid, under permeation conditions, with the retentate sides of the membranes in the interior enclosures of a plurality of membrane devices, the membrane devices (i) comprising membranes having interior retentate surfaces and exterior permeate surfaces, (ii) including porous support members for supporting the membranes, and (iii) having interior enclosures including surfaces which comprise the interior retentate surfaces, thereby passing water or water vapor as permeate from the aqueous industrial fluid on the interior retentate surfaces through the membrane devices to the exterior permeate surfaces of the membranes while also filtering the aqueous industrial fluid and producing a concentrated retentate fluid within the membrane devices, (b) contacting the permeate sides of the membranes of the membrane devices with flowing air to enhance evaporation of the permeate therefrom, (c) collecting permeate which falls by gravity from the membrane devices, and (d) recovering a reduced volume aqueous industrial fluid from the interiors of the membrane.

1. An array of membrane devices useful for separating phases of an aqueous fluid, said membrane devices being capable, under permeating conditions, of permeating water as liquid or vapor, comprising (a) a plurality of membrane devices, said membrane devices having an exterior and an interior, deployed in a plurality of levels so that heated or unheated aqueous fluid on the exterior of said membrane devices on a higher level may fall by gravity onto the exterior of at least one membrane device on a lower level (b) means for moving heated or unheated air past the exterior of said membrane devices to enhance evaporation of water from said aqueous fluid when it is on the exterior of said membrane devices, and (c) means for moving aqueous fluid into or out of the interior of said membrane devices.

2. The array of membrane devices of claim 1 including means for placing an aqueous fluid on or into said array to contact the exteriors of at least some of said membrane devices.

3. The array of membrane devices of claim 1 wherein said means for moving aqueous fluid in element (c) is a vacuum pump, and wherein said membrane devices are connected to said vacuum pump to facilitate collection of permeate from said membrane devices.

4. The array of membrane devices of claim 1 wherein said means for moving aqueous fluid in element (c) is a pump for moving said aqueous fluid into said interiors of said membrane devices under pressure, and wherein said water evaporated in element (b) is permeate from said membrane devices.

5. The array of membrane devices of claim 4 wherein said membrane devices are connected in series so that said aqueous fluid is moved from the interior of one membrane device to the interior of another membrane device.

6. The array of membrane devices of claim 1 wherein said means for moving air is a fan.

7. The array of membrane devices of claim 1 substantially surrounded by a shroud.

8. The array of membrane devices of claim 1 having a basin under it for collecting liquid and solids falling by gravity from said array of membrane devices.

9. Method of processing an aqueous industrial fluid comprising
(a) placing said fluid on the retentate surfaces of a plurality of membrane devices, each membrane device having a retentate surface and a permeate surface,
(b) causing heated or unheated air to flow past said retentate surfaces to facilitate evaporation of water from said fluid on said retentate surfaces,
(c) subjecting said permeate surfaces of said membrane devices to a vacuum to assist the permeation of water or water vapor through said membrane device, and
(d) collecting concentrated fluid which falls by gravity from said retentate surface in a concentrated fluid collector.

10. Method of claim 9 including heating said aqueous industrial fluid prior to step (a), and optionally recycling at least some concentrated fluid from step (d) for reheating and inclusion in step (a).

11. Method of claim 10 wherein said heating is performed in a cavitation device.

12. Method of claim 9 wherein said membrane devices are arrayed to facilitate drainage of said aqueous fluid from the retentate surfaces of at least some membrane devices to the retentate surfaces of at least some other membrane devices.

13. Method of claim 9 wherein said concentrated fluid collected in step (d) includes solids which settle in said collector.

14. Method of claim 9 including collecting water or water vapor of step (c) and storing or using it as clean water.

15. Method of reducing the volume of an aqueous industrial fluid comprising
(a) contacting said aqueous industrial fluid, under permeation conditions, with the retentate surfaces of the membranes in the interior enclosures of a plurality of membrane devices, said membrane devices
(i) comprising membranes having interior retentate surfaces and exterior permeate surfaces, and optional porous supports, and
(ii) having interior enclosures including surfaces which comprise said interior retentate surfaces,
thereby passing water or water vapor as permeate from said aqueous industrial fluid on said interior retentate surfaces through said membrane devices to the exterior permeate surfaces of said membranes while also filtering said aqueous industrial fluid and producing a concentrated retentate fluid within said membrane devices,
(b) contacting said permeate sides of said membranes of said membrane devices with heated or unheated flowing air to enhance evaporation of said permeate therefrom,
(c) collecting permeate which falls by gravity from said membrane devices, and
(d) recovering a reduced volume aqueous industrial fluid from the interior enclosures of said membrane devices.

16. Method of claim 15 wherein said aqueous industrial fluid has a temperature of at least 60° C. when it is contacted with the retentate surfaces of the membranes in step (a).

17. Method of claim 15 wherein said aqueous industrial fluid is heated by a cavitation device prior to step (a).

18. Method of claim 15 wherein at least some of said membrane devices are dead end devices, and wherein at least some of said membrane devices are lower than others of said membrane devices and positioned to receive drainage of unevaporated permeate from said others onto the exteriors of said lower membrane devices.

19. Method of claim 15 wherein at least some of said membrane devices are cross flow devices, and wherein at least some of said membrane devices are lower than others of said membrane devices and positioned to receive drainage of unevaporated permeate from said others onto the exteriors of said lower membrane devices.

20. Method of claim 15 wherein said aqueous fluid is contacted in step (a) with the retentate surfaces of said membrane devices in series, thereby establishing cross flow filtration in said membrane devices seriatim.
